(19) United States
(12) Patent Application Publication
(10) Pub. No.: US 2026/0094552 A1
(43) Pub. Date: Apr. 2, 2026

(54) PIXEL CONTROL CIRCUIT AND DISPLAY PANEL

(71) Applicant: HKC CORPORATION LIMITED, Shenzhen (CN)

(72) Inventors: Hongcai Deng, Shenzhen (CN); Jun Shi, Shenzhen (CN); Tingting Yang, Shenzhen (CN); Lidan Ye, Shenzhen (CN)

(21) Appl. No.: 19/332,042

(22) Filed: Sep. 18, 2025

(30) Foreign Application Priority Data
Sep. 30, 2024 (CN) 202411392459.0

(51) Int. Cl. G09G 3/00; G09G 3/20

(52) U.S. Cl. CPC G09G 3/035; G09G 3/2003; G09G 2300/0452; G09G 2310/0297; G09G 2310/08; G09G 2320/0242

(57) ABSTRACT

The present application provides a pixel control circuit and a display panel. The display panel includes a plurality of pixel units, each pixel unit includes an original pixel and a compensation pixel. The pixel control circuit includes a row drive module, a column drive module, and a plurality of column signal branches; each column signal line is connected to each pixel unit of the corresponding column through at least two column signal branches, and the original pixel and the compensation pixel in pixel units of each column are respectively connected to different column signal branches of the corresponding column; the column drive module is configured to output data signals to the column signal branches corresponding to the original pixel and the compensation pixel when the display panel is in a stretched state, so that the original pixel and the compensation pixel are in an activated state.

### CROSS REFERENCE TO RELATED APPLICATION

Pursuant to 35 U.S.C. § 119 and the Paris Convention Treaty, the present application claims the benefit of Chinese Patent Application No. 202411392459.0 filed September 30, 2024, the contents of which are incorporated herein by reference.

### TECHNICAL FIELD

The present application relates to the technical field of display panels, and more particularly to a pixel control circuit and a display panel.

### BACKGROUND

With the development of the display industry, conventional rigid display screens can no longer meet the requirements of multiple scenarios. Flexible stretchable display screens, as a new form of display device, can be applied to multiple scenarios, thus attracting widespread attention from consumers. In recent years, based on display technologies such as Organic Light Emitting Diodes (OLED), Light Emitting Diodes (LCD), and Miniature Light Emitting Diodes (Mini LED), etc. The display pixel units, connecting wires, and light emitting units are formed on flexible substrates of organic materials to form stretchable display devices that can stretch/contract in a specific direction and change to a fixed shape. The stretchable display devices can be used in small-size screen applications such as wearable and handheld displays, but with the development of technology, they will be more commonly used in large-size (television, TV) in the future.

In the existing stretchable display products, when the screen is stretched, the distance between pixels in the display area will increase, and the resolution will decrease accordingly, which will result in different resolutions of the display screen before and after stretching, and the display effect will deteriorate.

### SUMMARY

In view of this, the embodiment of the present application provides a pixel control circuit and a display panel to solve the problem that the resolution of traditional stretchable display products decreases and the display effect deteriorates when stretched.

A first aspect of the embodiment of the present application provides a pixel control circuit for a display panel, the display panel includes a plurality of pixel units, wherein the plurality of pixel units are arranged in an array, each of the plurality of pixel units includes an original pixel and a compensation pixel, the compensation pixel includes a row compensation pixel and a column compensation pixel, the row compensation pixel is arranged between original pixels of any two adjacent columns, and the column compensation pixel is arranged between original pixels of any two adjacent rows;

the pixel control circuit includes a row drive module, a column drive module, a plurality of row signal lines, a plurality of column signal lines, and a plurality of column signal branches;

the row drive module is connected to the plurality of row signal lines, the column drive module is connected to the plurality of column signal lines, each of the plurality of row signal lines is connected to each of the plurality of pixel units of a corresponding row, each of the plurality of column signal lines is connected to each of the plurality of pixel units of a corresponding column through at least two column signal branches, and the original pixel and the compensation pixel in each column pixel unit are respectively connected to different column signal branches of a corresponding column;

the row drive module is configured to output a row scanning signal to the plurality of pixel units through the plurality of row signal lines; and

the column drive module is configured to output a data signal to the column signal line corresponding to the original pixel when the display panel is in a natural state, so that the original pixel is in an activated state, and to output a data signal to the column signal branches respectively corresponding to the original pixel and the compensation pixel when the display panel is in a stretched state, so that the original pixel and the compensation pixel are in an activated state.

A second aspect of the embodiment of the present application provides a display panel, including a pixel control circuit as provided in the first aspect of the embodiment of the present application.

The first aspect of embodiment of the present application provides the pixel control circuit for the display panel, the display panel includes a plurality of pixel units, wherein the plurality of pixel units are arranged in an array, each of the plurality of pixel units includes an original pixel and a compensation pixel, the compensation pixel includes a row compensation pixel and a column compensation pixel, the row compensation pixel is arranged between original pixels of any two adjacent columns, and the column compensation pixel is arranged between original pixels of any two adjacent rows; the pixel control circuit includes a row drive module, a column drive module, a plurality of row signal lines, a plurality of column signal lines, and a plurality of column signal branches; the row drive module is connected to the plurality of row signal lines, the column drive module is connected to the plurality of column signal lines, each of the plurality of row signal lines is connected to each of the plurality of pixel units of a corresponding row, each of the plurality of column signal lines is connected to each of the plurality of pixel units of a corresponding column through at least two column signal branches, and the original pixel and the compensation pixel in each column pixel unit are respectively connected to different column signal branches of a corresponding column; the row drive module is configured to output a row scanning signal to the plurality of pixel units through the plurality of row signal lines; and the column drive module is configured to output a data signal to the column signal line corresponding to the original pixel when the display panel is in a natural state, so that the original pixel is in an activated state, and to output a data signal to the column signal branches respectively corresponding to the original pixel and the compensation pixel when the display panel is in a stretched state, so that the original pixel and the compensation pixel are in an activated state. In the present application, each pixel unit is provided with an original pixel and a compensation pixel, and the original pixel and the compensation pixel can be driven in time-sharing manner through different column signal branches, so that only the original pixel can be driven when the display panel is not stretched, and when the display panel is stretched, the compensation pixel is driven to compensate the stretching gap, so as to achieve compensation of resolution and ensure the display effect during stretching. In addition, since the time-sharing driving of the original pixels and the compensation pixels does not rely on the Gate On Array (GOA) implementation, it will not cause the design area of the GOA unit to increase, therefore the border width of the panel will not be caused to increase, so as to ensure the narrow border effect.

It can be understood that the beneficial effects of the second aspect mentioned above can be referred to the relevant description in the first aspect mentioned above, which will not be repeated here.

### BRIEF DESCRIPTION OF THE DRAWINGS

In order to more clearly illustrate the technical solutions in the embodiments of the present application, the drawings required to be used in the embodiments or prior art descriptions will be briefly introduced below. Obviously, the drawings described below are only some embodiments of the present application. For those skilled in the art, other drawings can also be obtained based on these drawings without creative work.

FIG. 1 is a structural schematic diagram of a pixel control circuit provided in an embodiment of the present application;

FIG. 2 is a structural schematic diagram of a pixel unit provided in an embodiment of the present application;

FIG. 3 is a schematic diagram of a pixel display after stretching in a row direction provided in an embodiment of the present application;

FIG. 4 is a schematic diagram of a pixel display after stretching in row and column directions provided in an embodiment of the present application;

FIG. 5 is a structural schematic diagram of a pixel control circuit provided in another embodiment of the present application;

FIG. 6 is a structural schematic diagram of a pixel control circuit provided in another embodiment of the present application; and

FIG. 7 is a schematic diagram of a pixel drive timing provided in an embodiment of the present application.

The reference numerals in the figures are listed as following:

1-pixel array, 10-pixel unit, 11-original pixel, 12-compensation pixel, 121-row compensation pixel, 122-column compensation pixel; and

2-pixel control circuit, 21-row drive module, 22-column drive module, 23-row signal line, 24-column signal line, 25-column signal branch, 251-first column signal branch, 252-second column signal branch, 253-third column signal branch 253, 26-switch module, 27-control signal line.

### DESCRIPTION OF THE EMBODIMENTS

In the following description, specific details such as specific system structure, technology, etc. are presented for illustration rather than qualification in order to fully understand the embodiments of the present application. However, it should be clear to those skilled in the art that the present application may also be realized in other embodiments without these specific details. In other cases, detailed descriptions of well-known systems, devices, circuits and methods are omitted so as not to prejudice the description of the present application with unnecessary details.

It should be understood that when used in the specification of the present application and the appended claims, the term "include" indicates the presence of the described features, wholes, steps, operations, elements and/or components, but does not exclude the presence or addition of one or more other features, wholes, steps, operations, elements, components and/or their collections.

It should also be understood that the term "and/or" used in the specification of the present application and the appended claims refers to any combination of one or more of the associated listed items and all possible combinations, and includes these combinations.

In addition, in the description of the specification of the present application and the appended claims, the terms "first", "second", "third", etc. are only used to distinguish the description, and cannot be understood as indicating or implying relative importance.

References to "one embodiment" or "some embodiments", etc. as described in the description of the present application means that specific features, structures, or features described in conjunction with the embodiments are included in one or more embodiments of the present application. Thus, the terms "in one embodiment", "in some embodiments", "in some other embodiments", "in some further embodiments", etc., which appear in differences in the specification, do not necessarily all refer to the same embodiments, but mean "one or more but not all embodiments" unless otherwise specifically emphasized. The terms "including", "containing", "having" and their variations all mean "including but not limited to" unless otherwise specifically emphasized. The terms "include", "contain", "possess" and their variations all imply "include but are not limited to", unless otherwise specifically emphasized.

### Embodiment 1

The pixel control circuit of the display panel provided in the embodiment of the present application, the display panel includes a plurality of pixel units, wherein the plurality of pixel units are arranged in an array, each of the plurality of pixel units includes an original pixel and a compensation pixel, the compensation pixel includes a row compensation pixel and a column compensation pixel, the row compensation pixel is arranged between original pixels of any two adjacent columns, and the column compensation pixel is arranged between original pixels of any two adjacent rows; the pixel control circuit includes a row drive module, a column drive module, a plurality of row signal lines, a plurality of column signal lines, and a plurality of column signal branches; the row drive module is connected to the plurality of row signal lines, the column drive module is connected to the plurality of column signal lines, each of the plurality of row signal lines is connected to each of the plurality of pixel units of a corresponding row, each of the plurality of column signal lines is connected to each of the plurality of pixel units of a corresponding column through at least two column signal branches, and the original pixel and the compensation pixel in each column pixel unit are respectively connected to different column signal branches of a corresponding column; the row drive module is configured to output a row scanning signal to the plurality of pixel units through the plurality of row signal lines; and the column drive module is configured to output a data signal to the column signal line corresponding to the original pixel when the display panel is in a natural state, so that the original pixel is in an activated state, and to output a data signal to the column signal branches respectively corresponding to the original pixel and the compensation pixel when the display panel is in a stretched state, so that the original pixel and the compensation pixel are in an activated state. In the present application, each pixel unit is provided with an original pixel and a compensation pixel, and the original pixel and the compensation pixel can be driven in time-sharing manner through different column signal branches, so that only the original pixel can be driven when the display panel is not stretched, and when the display panel is stretched, the compensation pixel is driven to compensate the stretching gap, so as to achieve compensation of resolution and ensure the display effect during stretching. In addition, since the time-sharing driving of the original pixels and the compensation pixels does not rely on the Gate On Array (GOA) implementation, it will not cause the design area of the GOA unit to increase, therefore the border width of the panel will not be caused to increase, so as to ensure the narrow border effect.

In applications, the display panel can be a Liquid Crystal Display (LCD), a Thin Film Transistor Liquid Crystal Display (TFT-LCD), and other display panels based on backlight sources for display. The display panel is a stretchable display panel, and "stretchable" can refer to the ability of a material, structure, device, or device component to withstand tensile deformation (e.g., lengthening and/or widening) without permanent deformation or failures such as rupture, for example, the ability to stretch at least 1.5 times its length without permanent deformation, cracking, or breaking. The term is also intended to include a substrate having components (regardless of whether these components themselves are stretchable as above) constructed in the following manner: it accommodates a stretchable, expandable, or expandable surface, and maintains functionality when applied to a stretchable, expandable, or expandable surface that is stretched, expanded, or expanded, respectively. The term is also intended to encompass substrates that can be elastically and/or plastically deformed (i.e., after being stretched, the substrate can return to its original size when the stretching force is released, or the substrate can not return to its original size and in some embodiments can remain in the stretched state), and can be deformed (i.e., stretched and optionally bent) during the manufacture of the substrate, during the assembly of a device incorporating the substrate (which can be considered as part of the manufacturing process), and/or during use (e.g., a user can stretch and optionally bend the substrate).

In applications, the pixels of the display screen are designed to have a special grid-like "island" structure. The pixel unit is used in a multi-color display panel and is used to refer to any part of a pixel that can be independently addressed to emit a specific color. For example, a blue pixel unit is a part of a pixel that can be addressed to emit blue light. In a full-color display, a pixel typically includes three primary color pixel units, i.e., blue, green and red. Optionally, a pixel unit refers to a single light-emitting element.

In applications, the row drive module 21 is a GOA unit of the display panel, also known as a gate drive unit, for outputting a row scan signal. The column drive module 22 is a source drive unit of the display panel, which is used to output the data signal.

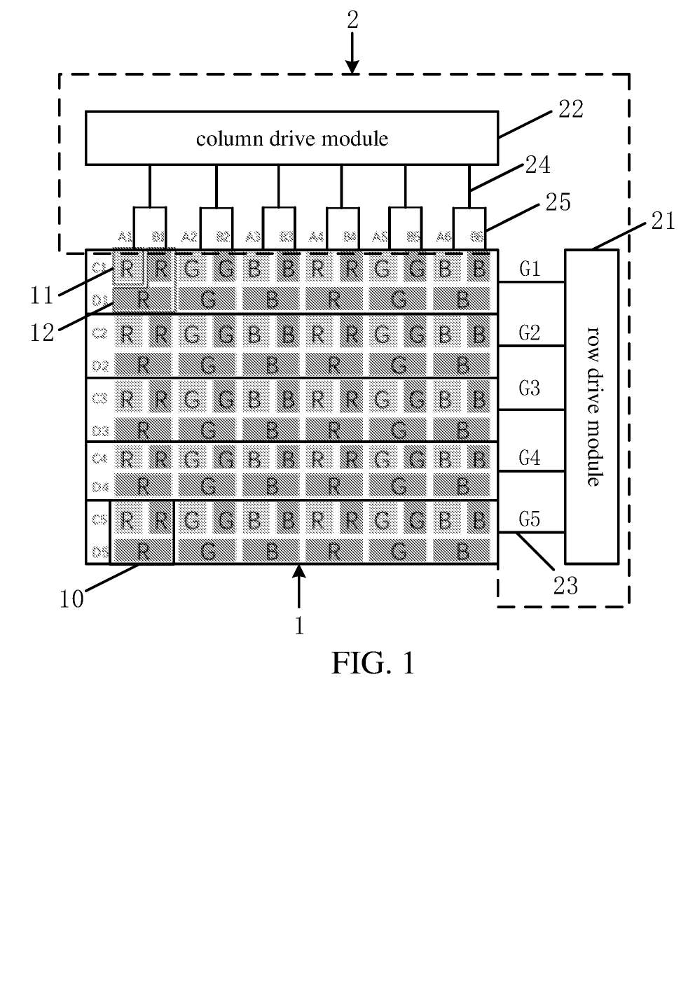

As shown in FIG. 1, the pixel control circuit 2 for the display panel provided in the embodiment of the present application is applied to the display panel. The pixel array 1 of the display panel includes a plurality of pixel units 10, and the plurality of pixel units 10 are distributed in an array. Each pixel unit 10 includes an original pixel 11 and a compensation pixel 12. The compensation pixel 12 includes a row compensation pixel 121 and a column compensation pixel 122. The row compensation pixel 121 is arranged between any two adjacent columns of original pixels 11, and the column compensation pixel 122 is arranged between any two adjacent rows of original pixels 11.

The pixel control circuit 2 includes a row drive module 21, a column drive module 22, a plurality of row signal lines 23, a plurality of column signal lines 24, and a plurality of column signal branches 25.

The row drive module 21 is connected to each row signal line 23, and the column drive module 22 is connected to each column signal line 24. Each row signal line 23 is connected to each pixel unit 10 of the corresponding row, and each column signal line 24 is connected to each pixel unit 10 of the corresponding column through at least two column signal branches 25. The original pixel 11 and the compensation pixel 12 in each column pixel unit 10 are respectively connected to different column signal branches 25 of the corresponding column.

The row drive module 21 is used to output a row scanning signal to each pixel unit 10 through each row signal line 23.

The column drive module 22 is used to output a data signal to each column signal line 24 corresponding to the original pixel 11 when the display panel is in a natural state, so that the original pixel 11 is in an activated state, and when the display panel is in a stretched state, the column drive module 22 outputs a data signal to the column signal branches 25 corresponding to the original pixel 11 and the compensation pixel 12 respectively, so that the original pixel 11 and the compensation pixel 12 are in an activated state.

In applications, the row compensation pixel 121 and the column compensation pixel 122 can be an L-shaped pixel, one end of which is used to compensate the gap between row pixels and the other end of which is used to compensate the gap between column pixels. The row compensation pixel 121 and the column compensation pixel 122 can also be two independent pixels, which are used to compensate the gap between row pixels and the gap between column pixels respectively. When the row compensation pixel 121 and the column compensation pixel 122 are two independent pixels, the row compensation pixel 121 and the column compensation pixel 122 can be used as a whole to synchronously write data signals, or as two independent pixels to write data signals in time-sharing.

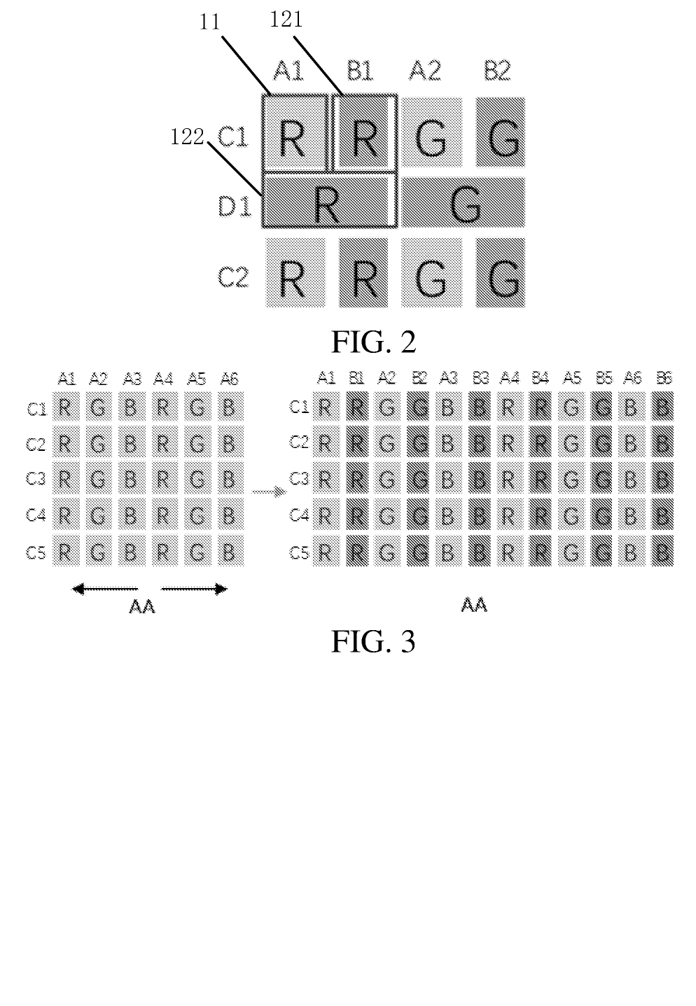

In applications, the above scheme is explained with 5 rows and 5 columns of pixels. As shown in FIG. 2, each pixel unit 10 is composed of an original pixel 11 and a compensation pixel 12. The compensation pixel 12 includes a row compensation pixel 121 and a column compensation pixel 122, and the row compensation pixel 121 and the column compensation pixel 122 form an L shape, so that after cooperating with the original pixel 11, a pixel unit 10 similar in shape to the original pixel 11 is formed. Taking the pixel unit 10 of the 1st row and the 1st column as an example, which includes the original pixel A1C1 and the compensation pixel. The compensation pixel is composed of the row compensation pixel B1C1 and the column compensation pixel B1D1.

In applications, the row drive module 21 scans the pixel units of each row in the pixel array through each row signal line 23. Among them, the row signal line G1 is connected to all the pixel units of the first row to activate all the pixel units of this row. In the natural state and the stretched state, both the original pixel and the compensation pixel are activated, that is, all the pixels of the C1 and D1 rows are activated. Similarly, the row signal line G2 is used to activate all the pixels of the C1 and D1 rows, the row signal line G2 is used to activate all the pixels of the C2 and D2 rows, the row signal line G3 is used to activate all the pixels of the C3 and D3 rows, the row signal line G4 is used to activate all the pixels of the C4 and D4 rows, and the row signal line G5 is used to activate all the pixels of the C5 and D5 rows.

In applications, the column drive module 22 outputs data signals through the column signal lines 24 so that the pixel units connected to each column signal line 24 displays the corresponding brightness. In order to realize the time-sharing drive of the original pixel and the compensation pixel in each column pixel unit, at least two column signal branches 25 are connected to the output end of each column signal line 24, and the original pixel and the compensation pixel are driven respectively through different column signal branches 25. According to the number of column signal branches 25, the compensation pixels can be driven as a whole, or the row compensation pixel 121 and the column compensation pixel 122 in the compensation pixels can be driven in time-sharing manner.

In the embodiment of the present application, each pixel unit is provided with an original pixel and a compensation pixel, and the original pixel and the compensation pixel can be driven in time-sharing manner through different column signal branches, so that only the original pixel can be driven when the display panel is not stretched, and when the display panel is stretched, the compensation pixel is driven to compensate the stretching gap, so as to achieve compensation of the resolution and ensure the display effect during stretching. In addition, since the time-sharing drive of the original pixel and the compensation pixel does not rely on the Gate On Array (GOA), the design area of the GOA unit will not increase, and thus the border width of the panel will not increase, so as to ensure the narrow border effect. Due to the time-sharing drive of the original pixel and the compensation pixel, different data signals can be written to the original pixel and the compensation pixel through the column drive module 22, so that the original pixel and the compensation pixel can be charged to different degrees, so as to achieve different brightness and ensure a better display effect.

In one embodiment, the column drive module 22 is also used to:

output data signals to the column signal lines 24 corresponding to the original pixel 11 and the row compensation pixel 121 when the display panel is in a row stretched state, so that the original pixel 11 and the row compensation pixel 121 are in an activated state;

output data signals to the column signal lines 24 corresponding to the original pixel 11 and the column compensation pixel 122 when the display panel is in a column stretched state, so that the original pixel 11 and the column compensation pixel 122 are in an activated state; and

output data signals to the column signal lines 24 corresponding to the original pixel 11, the row compensation pixel 121, and the column compensation pixel 122 when the display panel is in a row and column stretched state, so that the original pixel 11, the row compensation pixel 121, and the column compensation pixel 122 are in an activated state.

In applications, as shown in FIG. 3, the AA direction in the figure is the row direction, and the other direction perpendicular to the AA direction is the column direction. When the display panel is in the natural state (i.e., not stretched), the column drive module 22 only charges the original pixel through the column signal branch connected to the original pixel, so that the original pixel is in the activated state (i.e., emitting light), while the column signal branch connected to the compensation pixel cannot receive the data signal, so that the compensation pixel is in a silent state (i.e., not emitting light). When the display panel is stretched along the row direction, the column drive module 22 charges the original pixel through the column signal branch connected to the original pixel, and also charges the compensation pixel through the column signal branch connected to the compensation pixel, so that both the original pixel and the compensation pixel begin to emit light. The luminous B1/ B2/ B3/ B4/ B5/ B6 column compensation pixels compensate for the gap formed by stretching in the A1/A2/A3/A4/A5 column original pixels, so that when stretched to one time in the row direction, the number of displayed pixels doubles, so as to realize the resolution compensation in the stretched state of the display panel.

Similarly, when the display panel is stretched along the column direction, the luminous D1/D2/D3/D4/D5 row compensation pixels compensate for the gaps formed by the stretching of the original pixels in the C1/C2/C3/C4/C5 rows, so that when the column direction is stretched to one time, the number of displayed pixels doubles, so as to achieve resolution compensation in the stretched state of the display panel.

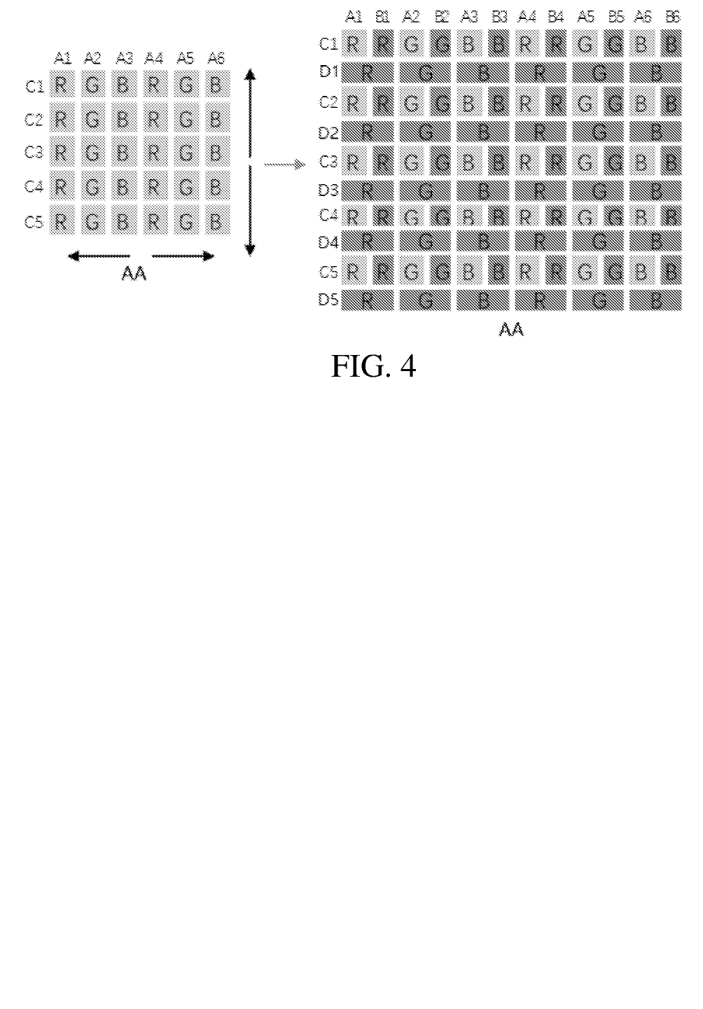

In applications, as shown in FIG. 4, when the display panel is stretched along the row and column directions, the column drive module 22 charges the original pixels through the column signal branch connected to the original pixels, and also charges the compensation pixels through the column signal branch connected to the compensation pixels, so that both the original pixels and the compensation pixels begin to emit light. The luminous B1/ B2/ B3/ B4/ B5/ B6 column compensation pixels compensate for the gaps formed by stretching the original pixels in the A1/A2/A3/A4/A5 columns; the luminous D1/ D2/ D3/ D4/ D5 row compensation pixels compensate for the gaps formed by stretching the original pixels in the C1/C2/C3/C4/C5 rows. The number of displayed pixels is doubled. Thus, the resolution compensation of the display panel in the stretched state is achieved.

### Embodiment 2

In one embodiment, the column signal branch 25 includes a first column signal branch 251 and a second column signal branch 252.

The original pixels 11 in the same column pixel unit 10 are connected to the first column signal branch 251 of the corresponding column.

The compensation pixels 12 in the same column pixel unit 10 are connected to the second column signal branch 252 of the corresponding column.

In applications, the row compensation pixel 121 and the column compensation pixel 122 are treated as a compensation pixel as a whole and synchronously receive data signals. The column signal branch 25 includes the first column signal branch 251 and the second column signal branch 252. The first column signal branch 251 is used to charge the original pixel 11, and the second column signal branch 252 is used to charge the row compensation pixel 121 and the column compensation pixel 122. The column drive module 22 realizes the drive decoupling of the original pixel 11 and the compensation pixel 12 through the first column signal branch 251 and the second column signal branch 252. For example, after the pixel units in the first row receive the row scanning signal, and when the column drive module 22 sends a data signal to the first column signal branch 251 of the first column of the pixel units in the first row, the original pixel A1C1 starts to charge. When the column drive module 22 sends a data signal to the second column signal branch 251 of the first column of the pixel units in the first row, the compensation pixel (including B1C1 and B1D1) starts to charge.

### Embodiment 3

In one embodiment, the column signal branch 25 includes a first column signal branch 251, a second column signal branch 252, and a third column signal branch 253.

The original pixels 11 in the same column pixel unit 10 are connected to the first column signal branch 251 of the corresponding column.

The row compensation pixels 121 in the same column pixel unit 10 are connected to the second column signal branch 252 of the corresponding column.

The column compensation pixels 122 in the same column pixel unit 10 are connected to the third column signal branch 253 of the corresponding column.

In applications, the row compensation pixel 121 and the column compensation pixel 122 can be used as two independent pixels to receive data signals respectively. The column signal branch 25 includes the first column signal branch 251, the second column signal branch 252, and the third column signal branch 253. The first column signal branch 251 is used to charge the original pixel 11, the second column signal branch 252 is used to charge the row compensation pixel 121, and the third column signal branch 253 is used to charge the column compensation pixel 122. The column drive module 22 realizes the driving decoupling of the original pixel 11 and the compensation pixel 12 through the first column signal branch 251 and the second column signal branch 252/the third column signal branch 253. The driving decoupling of the row compensation pixel 121 and the column compensation pixel 122 is realized through the second column signal branch 252 and the third column signal branch 253. For example, after the pixel units of the first row receive the row scanning signal, and when the column drive module 22 sends a data signal to the first column signal branch 251 of the first column of pixel units of the first row, the original pixel A1C1 starts to charge. When the column drive module 22 sends a data signal to the second column signal branch 252 of the first column of pixel units of the first row, the row compensation pixel B1C1 starts to charge. When the column drive module 22 sends a data signal to the third column signal branch 253 of the first column of pixel units of the first row, the column compensation pixel B1D1 starts to charge.

In the embodiment of the present application, due to the time-sharing driving of the original pixel and the compensation pixel, different data signals can be written to the original pixel and the compensation pixel through the column drive module 22, so that the original pixel and the compensation pixel can be charged to different degrees, so as to achieve different brightness. Further, the row compensation pixel 121 and the column compensation pixel 122 can also be time-sharing driven, so that the row compensation pixel 121 and the column compensation pixel 122 can also display different brightness, to further ensure a better display effect.

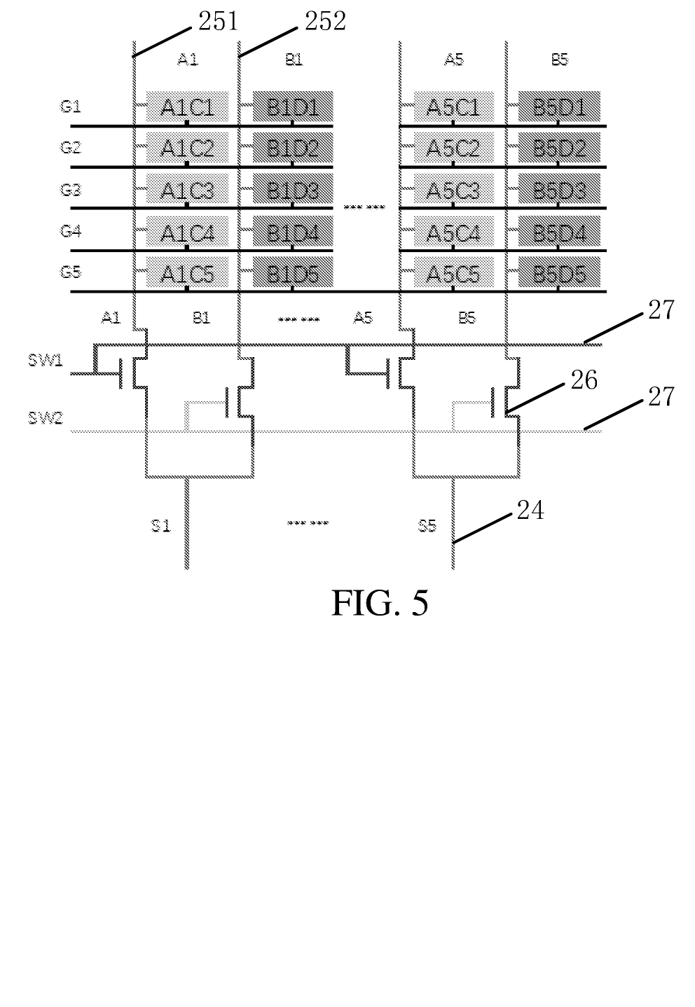

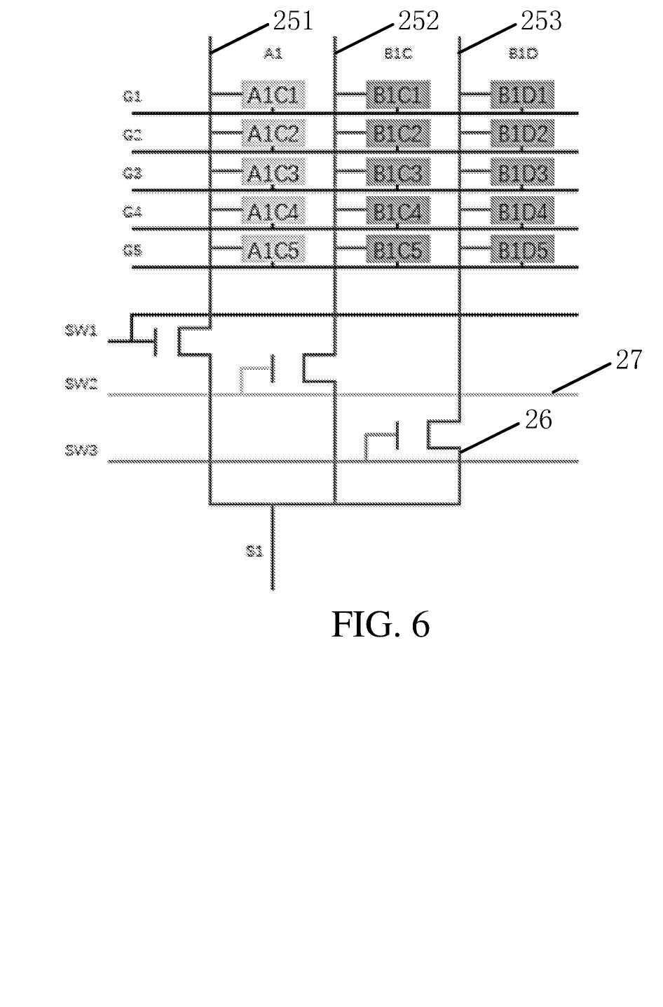

In one embodiment, as shown in FIGS. 5 and 6, each column signal line 24 is connected to each column signal branch 25 of the corresponding column through a switch module 26, and the controlled end of the switch module 26 is connected to the column drive module 22.

The column drive module 22 is further used to control the specified switch module 26 to be turned on, so that the data signal is output to the corresponding original pixel 11 and/or compensation pixel 12 through the specified column signal branch 25.

In applications, the switch module 26 can be a switch tube, or a switch unit including a switch tube and other components. When the switch module 26 includes a switch tube, the controlled end of the switch tube is controlled by the column drive module 22, so that the column drive module 22 can realize the switching of the switch tube. Since each column signal branch 25 is connected to a switch tube, when the switch tube is disconnected, the corresponding column signal branch 25 is disconnected. At this time, the data signal newly sent by the column drive module 22 through the column signal cannot be transmitted to the corresponding pixel through the disconnected column signal branch 25, so that the corresponding pixel will not be activated. On the contrary, when the switch tube is turned on, the corresponding column signal branch 25 is connected. At this time, the data signal newly sent by the column drive module 22 through the column signal can be transmitted to the corresponding pixel through the connected column signal branch 25, so that the corresponding pixel can be activated. In this way, the column drive module 22 can control the time-sharing activation of the original pixel and/or the compensation pixel by controlling the on and off of the switch tube, and can also control the time-sharing activation of the original pixel and/or the row compensation pixel and/or the column compensation pixel.

In one embodiment, the pixel control circuit further includes at least two control signal lines 27, the column drive module 22 is connected to the control signal lines 27, the control signal lines 27 are connected to the switch module 26, and the switch module 26 driving the original pixel 11 and the switch module 26 driving the compensation pixel 12 are respectively connected to different control signal lines 27.

In applications, as shown in FIG. 5, when the column signal branch 25 includes the first column signal branch 251 and the second column signal branch 252, the pixel units of each column correspond to two switch tubes and two corresponding control signal lines 27. The controlled end of the switch tube on the first column signal branch 251 of each column is connected to one control signal line, such as the control signal line SW1, and the controlled end of the switch tube on the second column signal branch 252 of each column is connected to another control signal line, such as the control signal line SW2. Therefore, when the column drive module 22 sends the first control signal through the control signal line SW1, the switch tubes on the first column signal branch 251 of each column can be turned on, so that all the original pixels can write data signals and start charging when receiving the row scan signal. When the column drive module 22 sends the second control signal through the control signal line SW2, the switch tubes on the second column signal branch 252 of each column can be turned on, so that all the compensation pixels can write data signals and start charging when receiving the row scan signal. Among them, the control signal transmitted on the control signal lines can be a switch signal to control the on and off of the switch tube (such as MOSFET, IGBT, etc.).

In applications, as shown in FIG. 6, when the column signal branch 25 includes the first column signal branch 251, the second column signal branch 252, and the third column signal branch 253, the pixel units of each column correspond to three switch tubes and three corresponding control signal lines 27. The controlled ends of the switch tubes on the first column signal branch 251 of each column are connected to one control signal line, such as the control signal line SW1, the controlled ends of the switch tubes on the second column signal branch 252 of each column are connected to another control signal line, such as the control signal line SW2, and the controlled ends of the switch tubes on the third column signal branch 253 of each column are connected to the remaining control signal line, such as the control signal line SW3. Therefore, when the column drive module 22 sends the first control signal through the control signal line SW1, the switch tubes on the first column signal branch 251 of each column can be turned on, so that all the original pixels can write data signals and start charging when receiving the row scanning signal. When the column drive module 22 sends the second control signal through the control signal line SW2, the switch tubes on the second column signal branch 252 of each column can be turned on, so that all the row compensation pixels can write data signals and start charging when receiving the row scanning signal. When the column drive module 22 sends the third control signal through the control signal line SW3, all the switch tubes on the third column signal branch 253 of each column can be turned on, so that all column compensation pixels can write data signals and start charging when receiving the row scanning signal.

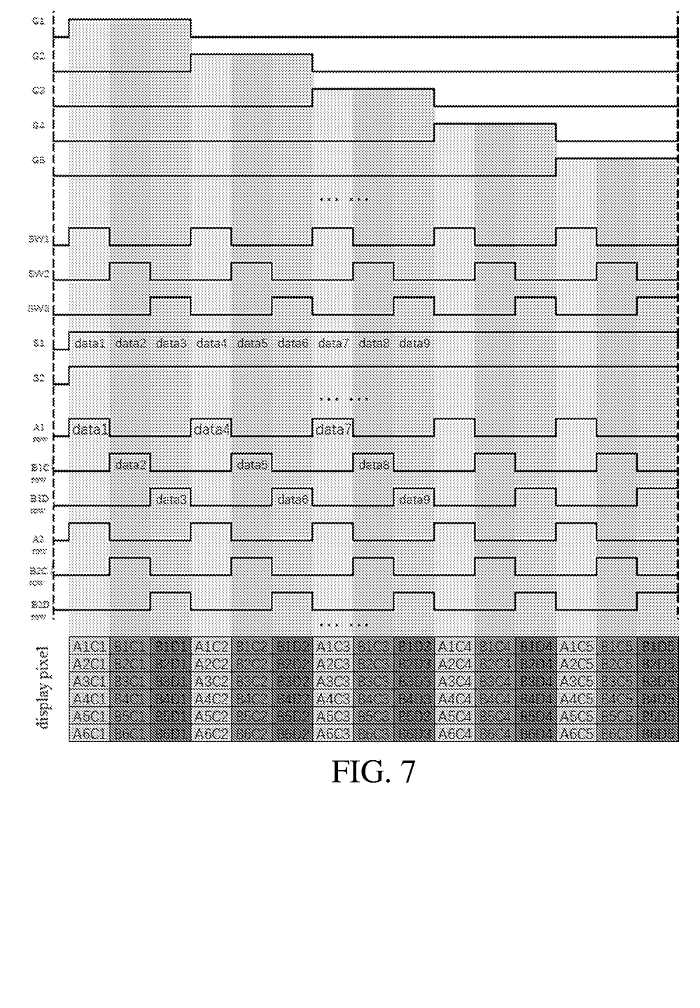

In applications, the driving principle of the embodiment of the present application is explained by taking the time-sharing driving of the original pixel 11, the row compensation pixel 121, and the column compensation pixel 122 as an example. As shown in FIG. 7, the original pixels and the compensation pixels of pixel units in a row are controlled by the same row signal line (i.e., the gate drive signal transmission line), and the same column signal line (i.e., the source drive signal transmission line) is used for time-sharing charging. In the natural state, the SW1 signal maintains a high level, the SW2 and SW3 signals maintain a low level, the switch tube controlled by the SW1 signal is always turned on, and the switch tube corresponding to the SW2 and SW3 signals is turned off, at this time, the compensation pixel does not display color. The source drive signal S1 charges the pixels in A1 column, the source drive signal S2 charges the pixels in A2 column, and so on. In the stretched state, all column signal lines charge the original pixels & row compensation pixels & column compensation pixels of the A column in a time-sharing manner, and the SW1, SW2 and SW3 signals are output in a time-sharing manner when each row of gate drive signals is output. S1 charges the pixels in the A1 column when the SW1 signal is at the high level, the source drive signal S1 charges the pixels in the B1C column when the SW2 signal is at the high level, and the source drive signal S1 charges the pixels in the B1D column when the SW3 signal is in the high level, and so on. If it is only a stretching display in the row direction, the SW3 signal can be kept at a low level, the row compensation pixels of the compensation pixels emit light, and the column compensation pixels do not emit light. If it is only a stretching display in the column direction, the SW2 signal can be kept at a low level, the column compensation pixels of the compensation pixels emit light, and the row pixels do not emit light, which is more flexible for different usage scenarios.

In applications, the display brightness of different pixels can be achieved by adjusting the voltage value output by the column signal line. For example, before stretching, the charging voltage of the A1C1 white screen is 12V. After stretching, the A1C1 charging voltage (data1) is 12V, the B1C1 charging voltage (data2) can be set to 11V according to the brightness requirements, and the B1D1 charging voltage (data3) can be set to 10.5V according to the brightness requirements. It can also be combined with different algorithms for some pictures to achieve better display effects.

Therefore, the original pixels, the row compensation pixels and, the column compensation pixels are charged separately, and the brightness of the row compensation pixels between pixels of rows and the brightness of the column compensation pixels between pixels of columns can be controlled separately, while improving the screen display resolution, it can also be applied to different usage scenarios or stretching in different directions, and the display brightness can be better adjusted during display. It can also be combined with different algorithms for some pictures to compensate the brightness of the original pixels or optimize the edges of graphics and text, so as to reduce the granularity of the screen display and achieve better display effects.

In one embodiment, the pixel control circuit further includes a multiplexing circuit, the input end of the multiplexing circuit is connected to the control signal output end of the column drive module 22, and the output end of the multiplexing circuit is connected to the control signal line 27.

The multiplexing circuit is used to send an enable signal to the corresponding control signal line 27 according to the control signal of the column drive module 22, so that the switch module 26 connected to the control signal line 27 is turned on.

In applications, the multiplexing circuit can be set at the control signal output end of the column drive module 22 to divide one control signal into three control signals, and control the switch modules connected to each other through the control signal lines SW1~SW3. The multiplexing circuit can be designed in the surface of the display panel or on a Chip On Glass (COF).

In one embodiment, the length of the row compensation pixel 121 is consistent with that of the original pixel 11 in the row direction, and the length of the column compensation pixel 122 in the row direction is the sum of the lengths of the row compensation pixel 121 and the original pixel 11 in the row direction.

In applications, in order to make the arrangement of the luminous pixels consistent with the natural state after the display panel is stretched, the length of the row compensation pixel 121 is consistent with that of the original pixel 11 in the row direction, and the length of the column compensation pixel 122 in the row direction is the sum of the lengths of the row compensation pixel 121 and the original pixel 11 in the row direction, so that the shape of each pixel unit can be consistent with the original pixel, so as to ensure a better display effect.

In one embodiment, the original pixel 11 and the compensation pixel 12 in the same pixel unit 10 have the same color, the pixel units 10 in the same column have the same color, the pixel units 10 in the same row have a plurality of colors and the adjacent pixel units 10 have different colors.

In applications, the original pixel 11 in a red pixel unit 10 is red, and the corresponding row compensation pixel 121 and column compensation pixel 122 are also red. The original pixel 11 in a green pixel unit 10 is green, and the corresponding row compensation pixel 121 and column compensation pixel 122 are also green. The original pixel 11 in a blue pixel unit 10 is blue, and the corresponding row compensation pixel 121 and column compensation pixel 122 are also blue. The pixel units 10 in the same column have a single color, such as any one of red, green, and blue. For a display panel that uses RGB to form an image, the pixel units 10 in the same row have three colors, namely red, green, and blue, and the three colors appear alternately. Thus, the adjacent pixel units 10 have different colors. For example, one side of a green pixel is red and the other side is blue.

### Embodiment 4

The embodiment of the present application also provides a display panel, which includes the pixel control circuit described in any of the above embodiments.

In applications, in order to detect the state of the display panel to determine whether the display panel is in a natural state, a row stretched state, or a column stretched state. A sensor can be set in the peripheral area of the display panel, and the stretched state of the display panel can be determined by monitoring the data of the sensor. The sensor can be a strain gauge sensor, a resistive sensor, a piezoelectric sensor, etc.

### Embodiment 5

The embodiment of the present application also provides a display device, which includes the display panel described in any of the above embodiments.

In the application, the display device is a display device having at least one function of displaying images, videos, and other visual information. The display device can be a television, a computer monitor, a mobile phone, a tablet computer, a wearable device, etc. The embodiment of the present application does not limit the specific type of the display device.

The above embodiments are only used to illustrate the technical solutions of the present application, rather than to limit them. Although the present application has been described in detail with reference to the aforementioned embodiments, those skilled in the art should understand that they can still modify the technical solutions described in the aforementioned embodiments, or make equivalent replacements for some of the technical features therein. These modifications or replacements do not deviate the essence of the corresponding technical solutions from the spirit and scope of the technical solutions of the embodiments of the present application, and should all be included in the protection scope of the present application.

What is claimed is:

1. A pixel control circuit for a display panel, wherein the display panel comprises a plurality of pixel units; the plurality of pixel units are arranged in an array, each of the plurality of pixel units includes an original pixel and a compensation pixel, the compensation pixel comprises a row compensation pixel and a column compensation pixel, the row compensation pixel is arranged between original pixels of any two adjacent columns, and the column compensation pixel is arranged between original pixels of any two adjacent rows;
the pixel control circuit comprises a row drive module, a column drive module, a plurality of row signal lines, a plurality of column signal lines, and a plurality of column signal branches;
the row drive module is connected to the plurality of row signal lines, the column drive module is connected to the plurality of column signal lines, each of the plurality of row signal lines is connected to each of the plurality of pixel units of a corresponding row, each of the plurality of column signal lines is connected to each of the plurality of pixel units of a corresponding column through at least two column signal branches, and the original pixel and the compensation pixel in each column pixel unit are respectively connected to different column signal branches of a corresponding column;
the row drive module is configured to output a row scanning signal to the plurality of pixel units through the plurality of row signal lines; and
the column drive module is configured to output a data signal to each column signal line corresponding to each original pixel when the display panel is in a natural state, so that the original pixel is in an activated state, and to output a data signal to the column signal branches respectively corresponding to the original pixel and the compensation pixel when the display panel is in a stretched state, so that the original pixel and the compensation pixel are in an activated state.

2. The pixel control circuit according to claim 1, wherein the column signal branch comprises a first column signal branch and a second column signal branch;
original pixels in pixel units of a same column are connected to the first column signal branch of the corresponding column; and
compensation pixels in pixel units of a same column are connected to the second column signal branch of the corresponding column.

3. The pixel control circuit according to claim 1, wherein the column signal branch comprises a first column signal branch, a second column signal branch, and a third column signal branch;
original pixels in pixel units in a same column are connected to the first column signal branch of the corresponding column;
row compensation pixels in pixel units in a same column are connected to the second column signal branch of the corresponding column; and
column compensation pixels in pixel units in a same column are connected to the third column signal branch of the corresponding column.

4. The pixel control circuit according to claim 1, wherein the column drive module is further configured to:
output data signals to column signal lines corresponding to the original pixel and the row compensation pixel when the display panel is in a row stretched state, so that the original pixel and the row compensation pixel are in an activated state;
output data signals to column signal lines corresponding to the original pixel and the column compensation pixel when the display panel is in a column stretched state, so that the original pixel and the column compensation pixel are in an activated state; and
output data signals to column signal lines corresponding to the original pixel, the row compensation pixel, and the column compensation pixel when the display panel is in a row and column stretched state, so that the original pixel, the row compensation pixel, and the column compensation pixel are in an activated state.

5. The pixel control circuit according to claim 1, wherein each column signal line is connected to each column signal branch of the corresponding column through one switch module, and a controlled end of the switch module is connected to the column drive module; and
the column drive module is further configured to control a specified switch module to be turned on, so that the data signal is output to a corresponding original pixel and/or compensation pixel through a specified column signal branch.

6. The pixel control circuit as claimed in claim 5, further comprising at least two control signal lines, the column drive module is connected to the at least two control signal lines, the at least two control signal lines are connected to the switch modules, and a switch module driving the original pixel and a switch module driving the compensation pixel are respectively connected to different control signal lines.

7. The pixel control circuit according to claim 6, further comprising a multiplexing circuit, an input end of the multiplexing circuit is connected to a control signal output end of the column drive module, and an output end of the multiplexing circuit is connected to the control signal line; and
the multiplexing circuit is configured to send an enable signal to a corresponding control signal line according to the control signal of the column drive module, so as to turn on the switch module connected to the control signal line.

8. The pixel control circuit according to claim 1, wherein a length of the row compensation pixel is consistent with that of the original pixel in a row direction, and a length of the column compensation pixel in the row direction is a sum of lengths of the row compensation pixel and the original pixel in the row direction.

9. The pixel control circuit according to claim 2, wherein a length of the row compensation pixel is consistent with that of the original pixel in a row direction, and a length of the column compensation pixel in the row direction is a sum of lengths of the row compensation pixel and the original pixel in the row direction.

10. The pixel control circuit according to claim 3, wherein a length of the row compensation pixel is consistent with that of the original pixel in a row direction, and a length of the column compensation pixel in the row direction is a sum of lengths of the row compensation pixel and the original pixel in the row direction.

11. The pixel control circuit according to claim 4, wherein a length of the row compensation pixel is consistent with that of the original pixel in a row direction, and a length of the column compensation pixel in the row direction is a sum of lengths of the row compensation pixel and the original pixel in the row direction.

12. The pixel control circuit according to claim 5, wherein a length of the row compensation pixel is consistent with that of the original pixel in a row direction, and a length of the column compensation pixel in the row direction is a sum of lengths of the row compensation pixel and the original pixel in the row direction.

13. The pixel control circuit according to claim 6, wherein a length of the row compensation pixel is consistent with that of the original pixel in a row direction, and a length of the column compensation pixel in the row direction is a sum of lengths of the row compensation pixel and the original pixel in the row direction.

14. The pixel control circuit according to claim 7, wherein a length of the row compensation pixel is consistent with that of the original pixel in a row direction, and a length of the column compensation pixel in the row direction is a sum of lengths of the row compensation pixel and the original pixel in the row direction.

15. The pixel control circuit according to claim 1, wherein the original pixel and the compensation pixel in a same pixel unit have a same color, the pixel units in the same column have a same color, the pixel units in a same row have a plurality of colors and adjacent pixel units have different colors.

16. A display panel, comprising a pixel control circuit; wherein the display panel comprises a plurality of pixel units; the plurality of pixel units are arranged in an array, each of the plurality of pixel units includes an original pixel and a compensation pixel, the compensation pixel comprises a row compensation pixel and a column compensation pixel, the row compensation pixel is arranged between original pixels of any two adjacent columns, and the column compensation pixel is arranged between original pixels of any two adjacent rows;
the pixel control circuit comprises a row drive module, a column drive module, a plurality of row signal lines, a plurality of column signal lines, and a plurality of column signal branches;
the row drive module is connected to the plurality of row signal lines, the column drive module is connected to the plurality of column signal lines, each of the plurality of row signal lines is connected to each of the plurality of pixel units of a corresponding row, each of the plurality of column signal lines is connected to each of the plurality of pixel units of a corresponding column through at least two column signal branches, and the original pixel and the compensation pixel in each column pixel unit are respectively connected to different column signal branches of a corresponding column;
the row drive module is configured to output a row scanning signal to the plurality of pixel units through the plurality of row signal lines; and
the column drive module is configured to output a data signal to each column signal line corresponding to each original pixel when the display panel is in a natural state, so that the original pixel is in an activated state, and to output a data signal to the column signal branches respectively corresponding to the original pixel and the compensation pixel when the display panel is in a stretched state, so that the original pixel and the compensation pixel are in an activated state.

17. The display panel according to claim 16, wherein the column signal branch comprises a first column signal branch and a second column signal branch;
original pixels in pixel units of a same column are connected to the first column signal branch of the corresponding column; and
compensation pixels in pixel units of a same column are connected to the second column signal branch of the corresponding column.

18. The display panel according to claim 16, wherein the column signal branch comprises a first column signal branch, a second column signal branch, and a third column signal branch;
original pixels in pixel units in a same column are connected to the first column signal branch of the corresponding column;
row compensation pixels in pixel units in a same column are connected to the second column signal branch of the corresponding column; and
column compensation pixels in pixel units in a same column are connected to the third column signal branch of the corresponding column.

19. The display panel according to claim 16, wherein the column drive module is further configured to:
output data signals to column signal lines corresponding to the original pixel and the row compensation pixel when the display panel is in a row stretched state, so that the original pixel and the row compensation pixel are in an activated state;
output data signals to column signal lines corresponding to the original pixel and the column compensation pixel when the display panel is in a column stretched state, so that the original pixel and the column compensation pixel are in an activated state; and
output data signals to column signal lines corresponding to the original pixel, the row compensation pixel, and the column compensation pixel when the display panel is in a row and column stretched state, so that the original pixel, the row compensation pixel, and the column compensation pixel are in an activated state.

20. The display panel according to claim 16, wherein each column signal line is connected to each column signal branch of the corresponding column through one switch module, and a controlled end of the switch module is connected to the column drive module; and
the column drive module is further configured to control a specified switch module to be turned on, so that the data signal is output to a corresponding original pixel and/or compensation pixel through a specified column signal branch.
